(19) United States
(12) Patent Application Publication
(10) Pub. No.: US 2009/0030778 A1
(43) Pub. Date: Jan. 29, 2009

(54) SYSTEM, METHOD AND APPARATUS FOR SECURE MULTIPARTY LOCATION BASED SERVICES

(75) Inventors: Daniel Zapata, San Jose, CA (US); Robert Ficcaglia, Redwood City, CA (US)

Correspondence Address: PERKINS COIE LLP, P.O. BOX 1208, SEATTLE, WA, 98111-1208, US

(73) Assignee: MotivePath, Inc.

(21) Appl. No.: 12/178,592

(22) Filed: Jul. 23, 2008

Related U.S. Application Data
(60) Provisional application No. 60/951,419, filed on Jul. 23, 2007.

(51) Int. Cl. G06Q 30/00; G06F 15/18; G01C 21/00

(52) U.S. Cl. 705/10; 706/21; 701/300

(57) ABSTRACT

A computer system implements a method to provide secure multiparty location based services. A user input is received from a user device of a user. The user input contains user location information. Based on the location information, a model is retrieved. The model is a constraint satisfaction problem defined by a set of variables and mapping functions. The set of variables and mapping functions are into multiple shares. Each share is distributed to one of agents in finding a solution to the constraint satisfaction problem. Once a solution is computed, a demographic profile is predicted based on the solution. The solution does not contain the user location information.

### CROSS REFERENCE TO RELATED APPLICATION

The present application is related to and claims the benefit of priority of the following commonly-owned, presently-pending provisional application: application Ser. No. 60/951,419 (Docket No. 64563-8002.US00), filed Jul. 23, 2007, entitled “System, Method and Apparatus for Secure Sharing of Location Data”, of which the present application is a non-provisional application thereof. Further, the present application is related to a provisional application with Ser. No. 60/945,907 (Docket No. 64563-8001.US00), filed Jun. 23, 2007, entitled “System, Method and Apparatus for Predictive Modeling of Spatially Distributed Data”, of which an application with Ser. No. 12/144,606, filed Jun. 23, 2008, claims the benefit of priority. The disclosures of the forgoing applications are hereby incorporated by reference in their entireties, including any appendices or attachments thereof, for all purposes.

### FIELD OF THE INNOVATION

At least one embodiment of the present invention pertains to a new method for collecting items of data pertaining to a human user's location via an electronic device location determination system, from such inputs executing one or more location based services such as marketing, risk analysis, or commerce tasks, collaborating in a secure way on such tasks with multiple computer system agents, and providing in aggregate a zero-knowledge multiparty solution.

### BACKGROUND

There has been explosive growth in the numbers and quality of indexing and data mining techniques designed to organize web content, such as web pages and videos, primarily for the purpose of keyword searching. Known as “behavioral targeting”, search engine marketing and search engine optimization techniques have attempted to track user behaviors, activities, and preferences, in order to classify web content according to these consumer behaviors and preferences. These techniques are intended to produce more relevant search results, better advertising and marketing results, and ultimately, more profits for practitioners. Yet, these existing methods are failing to adequately model user behavior in the “offline”, physical, geographic world where consumers really exist.

In many industries, data is spatially distributed under many simultaneous environmental stimuli. For example, a consumer may carry his mobile phone, PDA, or smart-phone from home to work to social events, resulting in a spatially distributed mobile device usage pattern. Also, the consumer uses the mobile device from time to time, causing the device usage to be time variable. The mobile device's current or past location data set can be useful in providing more specific advertising messages to the consumer. Although many existing data mining and statistical analysis techniques have tried to provide spatial data analysis, these methods relied upon a vast collection of user location records.

Further, access to a user's location information is considered highly confidential. There is a perceived risk of abuse or excessive use by data owners and 3rd parties who wish to provide the user with offers related to commercial goods and services. Collection and use of location information typically require explicit permission of the network and the consumer for any marketing-purposed use or share. Once collected, these records are queried whenever the user presents a new location data point, and a selection from a corpus of messages or services is subsequently made. Without the user's persistent location data store, such data mining and statistical tests would be impossible. Further, these methods are data intensive and machine resource intensive, meaning that the more user location data is collected, the more machine data storage and processing time are needed for generating efficient indexes and query parameters from the collected location data.

Using of “masking” to hide a user's true identity might be effective in traditional behavioral targeting, where advertisers correlate the past records of web site visits to a real-time choice of advertisement messages. If an attacker or abusive marketer were to access a database of “masked” behavioral targeting data, i.e. data cleansed of any personally identifying monikers (e.g., Social Security Number, Date of Birth, etc), it would be difficult to uniquely identify a user from these data. However, given the highly specific nature of location data, the user's home, place of business, school, and those of their families are apparent. If made available in real-time or near real-time, this data could be used to track an individual and presents an array of privacy concerns. Even masking the SSN or user name would do little to protect the user's home or work address derived from the location data. As such, even a small amount of location data could be abused easily.

The use of data aggregation, where the individual user records are stripped of identifying information, is also an inferior method. During aggregation, counts of users that visit a location are used, and from that aggregate data, statistical or probabilistic inferences can be made. However, the user must first trust that the data collection and aggregation process does not leak sensitive information. Second, the value of that aggregate data is reduced as it cannot be used to predict the future location pattern of any individual, nor draw inferences as to the individuals whose demographic profiles and preferences are likely to bring them to a particular location. Thus advertisers and marketers are forced to base their messages and creative work on a crude demographic clustering of users, with overlapping needs and tastes.

Another current method of location based marketing is “beacon” based, where the user's current proximity to a “beacon” or broadcasting terminal allows the marketer to deliver a coupon or message. In reverse, the user could be broadcasting location and the terminal at a fixed location could receive the user's signal and begin the same transaction. This limits the marketer to messages that are short-lived, and therefore rapidly decline in value and relevance. Further, the data collected by the beacon or terminal, namely that users have penetrated its monitoring range, can be used to track and identify a user, e.g. by phone number or device Serial Number, or Network MAC address.

When a 3^{rd} party wants to use a user's location to provide location based services to the user or a group of users, or the 3^{rd} party wants to map a particular user's location to a set of data, the current solutions require agents of each of the participating parties, or a central trusted agent, to have full access to the user's location data, and then rely on their security practices to prevent malicious, unauthorized, or unwanted use of the user's or subset of users' location data. For example, an iPhone application can access the native GPS location coordinates, pass this to a web service in the query string of a Universal Resource Locator (URL), which is received and stored persistently in the web server logs and a server-side database. Further, this data is often shared with 3^{rd} party advertisers who use this location data to target messages to the user. These 3^{rd} parties also have full access to the user's location coordinates, and can possibly store them persistently. At each node, the Internet Service Provider, or any other agent on the network, can intercept and extract the user's location information.

The other current solution is to not store or share location data and therefore prevent any usage. This certainly protects the user's privacy, but deprives them of useful services relevant to location-specific data and services. Even in cases where the user has acquiesced to the request for location data collection and sharing, the commercially valuable data derived from these location data are inherently limited to the transactions of interest to the specific location based service. There is not a way to apply the location data more generally, and to future transactions, i.e. given the user's location at the time, among several possible commercial offers, which is the most relevant offer most likely to lead to patronage.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1 illustrates a system environment in which certain embodiments of the present invention can be implemented;

FIG. 2-A illustrates an exemplary graphic representation of a geometric constraint system;

FIG. 2-B illustrates an exemplary approach in solving a private Distributed Constraint Satisfaction Problem (DistCSP);

FIG. 3-A illustrates an exemplary solution to a private distributed GCSP for providing map service;

FIG. 3-B illustrates an exemplary zero-knowledge proof;

FIG. 4 illustrates an exemplary Distributed Constraint Satisfaction Solver master Server;

FIG. 5 illustrates a service provider, according to certain embodiments of the present invention;

FIG. 6 illustrates a machine learning solver server, according to certain embodiments of the present invention;

FIG. 7 illustrates a client device, according to certain embodiments of the present invention;

FIG. 8 illustrate an exemplary flow diagram to provide secure multiparty location based services;

FIG. 9 illustrate an exemplary flow diagram to participate in providing secure multiparty location based services; and

FIG. 10 illustrate an exemplary flowchart for interactions among multiple components in providing secure multiparty location based services, in accordance with certain embodiments of the present invention.

### DETAILED DESCRIPTION

System, method, and apparatus for securely providing location based commercial services that require the collaboration of two or more service providers, e.g. marketing, advertising, fraud detection, payment services are described. In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments, of the invention.

In one embodiment, valuable commercial services can be provided to users by using a cryptographic identity, encryption and authentication system and a zero knowledge secure distributed proof scheme to allow two or more 3^{rd} parties to use users' location data for analysis, marketing, or other commercial purposes, without discovering or deducing during the process identifiable location data about any participating user, or subset of participating users. The system allows multiple service providers to collaborate in the computing and generating of useful solutions that are valuable for targeted commercial services. On the other hand, none of the service providers is allowed to have access to results generated by the other service providers. This is achieved by utilizing a zero-knowledge, securely-distributed proof allowing each of the service providers and the users to authenticate each other.

A user's location is initially available from a server which uses a network signal and a list of known antenna locations to pinpoint the user (control plane A-GPS). Or the user has a GPS chip (user plane), or several other means to automatically determine the device's location. The user's current and past location is encoded in a model that is unique to the user's location over time, but that cannot be used to unambiguously identify the user, even if the model is stolen or revealed in transit, or if one of the participants is a malicious entity (i.e. cheats). In addition, the user, by cryptographic means, can at any time authorize access to specific location information to any of the parties.

To allow location-based services and third parties, who cannot be trusted, to access these unique location models, a zero knowledge proof of location is constructed and shared among multiple parties. A zero-knowledge proof is an interactive method for one party to prove to another that a statement is true, without revealing anything other than the veracity of the statue. The proof in no way identifies a user's actual location (past or present), or allows deduction of a user's location patterns. However, the 3^{rd} party can deduce that a particular model is associated with a particular attribute set, and the inverse, that a particular attribute set corresponds to one or more models.

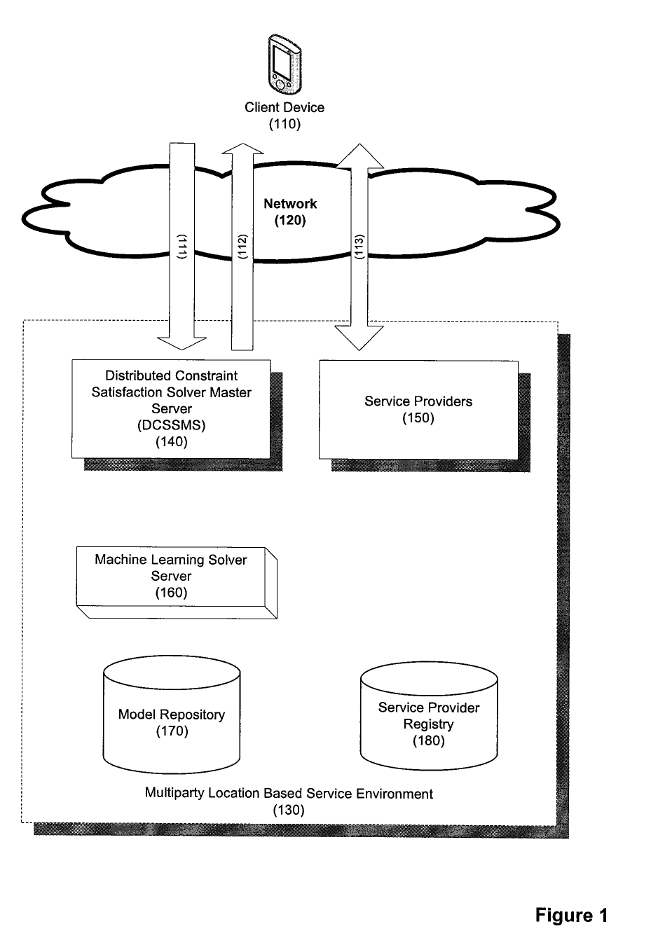

Referring now to FIG. 1, which shows an exemplary networked system environment in which the present invention may be implemented. In FIG. 1, a client device 110 communicates with various types of servers in a Multiparty Location Based Service Environment 130 via a network 120. The network 120 may be a wired network, such as local area network (LAN), wide area network (WAN), metropolitan area network (MAN), global area network such as the Internet, a Fibre Channel fabric, or any combination of such interconnects. The network 120 may also be a wireless network, such as mobile devices network (Global System for Mobile communication (GSM), Code Division Multiple Access (CDMA), Time Division Multiple Access (TDMA), etc), wireless local area network (WLAN), wireless Metropolitan area network (WMAN), etc.

The client device 110 refers to a computer system or a program from which a user request 111 may be originated. It can be a mobile, handheld computing/communication device, such as Personal Digital Assistant (PDA), cell phone, smart-phone, etc. The client device 110 can also be a conventional personal computer (PC), server-class computer, workstation, etc. In one embodiment, a client device 110 includes Global Positioning System (GPS) or similar location sensor that can track and transmit geographical location information.

In one embodiment, a Multiparty Location Based Service Environment 130 contains a Distributed Constraint Satisfaction Solver Master Server (DCSSMS) 140, a machine learning solver server 160, and multiple service providers 150, etc. The Multiparty Location based Service Environment 130 also contains a model repository 170, and a service provider registry 180. Each of the above components of the Multiparty Location based Service Environment 130 is further described below. Alternatively, the DCSSMS 140, the machine learning solver server 160, the model repository 170 can also be implemented in a client device 110.

In one embodiment, a user request 111 is sent, in wired or wireless fashion, directly or indirectly, from a client device 110 to a DCSSMS 140. In response to the user request 111, a respond message 112 is sent from the DCSMMS 140 and received by the client device 110. Examples of user request 111 include HTTP requests originated from clicking of an ingress web hyperlink, a Wireless Application Protocol (WAP) hyperlink, a link embedded in a mobile terminated (MT) Short Message Service (SMS) message, or a link embedded in a mobile originated (MO) SMS message, etc. Respond messages 112 can be in similar forms and be transmitted in similar fashions.

In one embodiment, a user request 111 includes geographic location information collected from the client device 110. The geographic location can be directly provided by an embedded GPS or location sensor that tracks the real-time location of the client device 110. Alternative, the user request 111 can include information that can be used to derived geographic location. For example, a user may input his location information such as address or zip code into a user interface displayed on the client device 110. Or the user request 111 may include an IP address of the client device 110, which can be used to estimate a location by identifying a network service provider and the area the service provider serving the IP address.

Similarly, by tracking the signals emanating from a mobile client device 110, a mobile phone tracker may accurately pinpoint the location of the mobile client device 110 based on assisted GPS, cell tower triangulation, WIFI AP triangulation, TV signal triangulation, or other means of calculations. In one embodiment, the geographic location information embedded in a user request 111 is described in latitude and longitude format. The location information can be relative to a known set of fixed points, e.g., cell towers, WIFI access points, IP routers, etc. Or, the location information can be within a known geographic projection system.

In one embodiment, in lieu of transmitting the actual location coordinate data, the geographic location information embedded in a user request 111 is encoded in a model produced on the client device 110 in the form of a Machine Learning Algorithm, such as a Support Vector Machine. The model encoding can be converted to a binary format suitable for transmission and reconstituted on the server. Similarly, a model, e.g., Support Vector Machine, can be created on a server, e.g., a DCSSMS 140, based on the location data transmitted by the client device 110. Once the model is created, the location data can be discarded.

In one embodiment, a DCSSMS 140 utilized the location data received from one or more client devices 110 for generating demographic information or class membership probability estimations. If any one of the service providers 150 is interested in the demographic information or class membership probability estimations derived from the location data, it can participate in the generating of such demographic information. The demographic information or class membership probability estimations are valuable to the service providers 150 in providing targeted commercial services to the client devices 110. The DCSSMS 140 manages and controls the distributed multiparty computing among the collaborating service providers 150, while maintaining security and privacy assurance to the users of the client devices 110 that none of their location data would be revealed to the service providers 150. The DCSSMS 140 itself can optionally be restricted from knowing all the components of the user's location or model, thus being a peer to other service providers 150.

In one embodiment, a service provider 150 can request for participation in the multiparty location based service environment 130. Once approved by the DCSSMS 140, the service provider's relevant information can be stored in a service provider registry 180 for further usage. By utilizing a DCSSMS 140, a service provider 150 can correlate demographic information to non-identifiable location data to determine things like the best location for a given preference set, or the most likely preferences at a given location. The goal is to allow queries over the domains of both the demographic and location data, but without divulging the location data of any particular user or group of users to the un-trusted party, while still allowing the un-trusted party to understand the strength of the correspondence for planning purposes.

In one embodiment, the DCSSMS 140 can allow for zero knowledge of a user's specific location, yet still allow for evaluation of location-specific mappings, e.g. to obtain for example a ranking of available choices of commercial offers and services. Later, when the computation must be verified (for example, for bidding systems or invoicing prices), the service provider's solution can be verified without compromising any intermediate values pertinent to the location or preference choices. In addition, the choices for price can be shown to be cheat-resistant.

In one embodiment, a machine learning solver server 160 can be deployed for providing various models enabling the generating of demographic information based on inputs from a client device 110 and the service providers 150. The generated models can be stored in a model repository 170 allowing instant accessing.

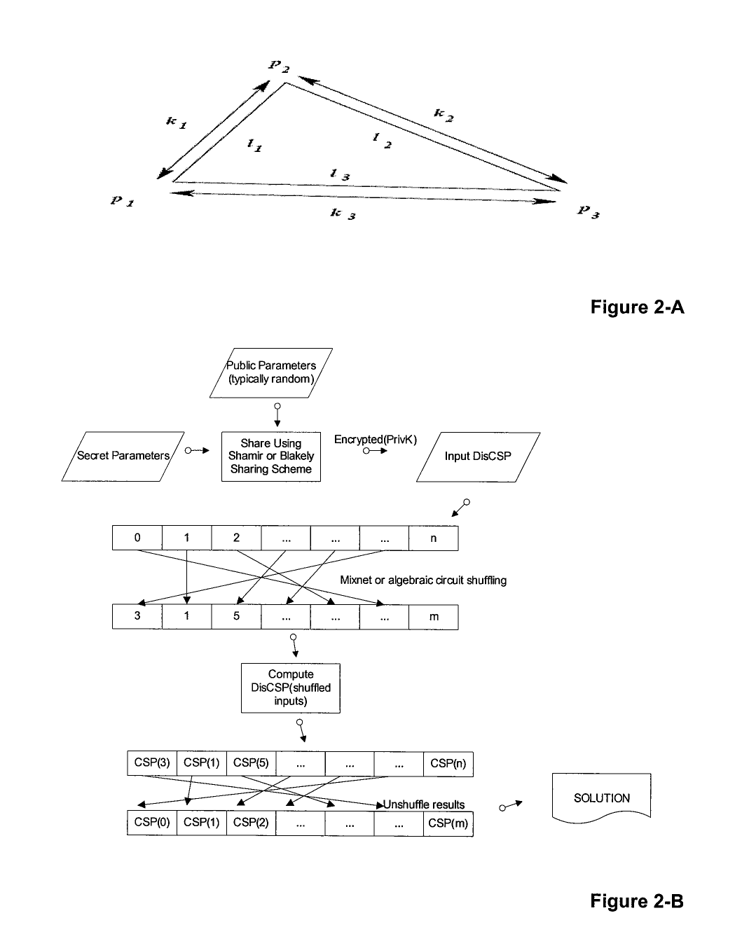

FIG. 2-A illustrates an exemplary graphic representation of a geometric constraint system. A constraint satisfaction problem (CSP) is defined by a set of variables X1-Xn, and a set of constraints C1-Cn. Each variable Xi has a domain of possible values. Each constraint Ci involves some subset of the variables and specifies the allowable combination of values for that subset. A solution to a CSP is a complete assignment of values to variables that satisfies all the constraints. For example, coloring each region of a map with limited number of color in a way that no neighboring regions having the same color is a CSP problem. The variables include each of the regions, a domain of possible values for the variables (regions) is a set of available colors, and the constraints include allowable combinations of two colors selected from the set of available colors.

One approach in solving a CSP is backtracking search, which is a form of depth-first search. Backtracking search chooses values for one variable at a time (selecting one color for one region at a time). When a variable has no legal value (not value that satisfies all the constraints) to assign, the search algorithm backtracks to a previous variable, and tries a different value for that variable. The algorithm further moves-forward and backtracks among the variables until a satisfactory solution is found for all the variables. Again, a solution to a CSP is an assignment of values to each of the variables from their domains such that no constraints are broken.

In one embodiment, a geographic (geometric) constraint satisfaction problem (GCSP) is a CSP in which the variables are geometric objects, the values are the possible locations of those objects in space (e.g. six-dimensional vectors with three position components and three orientation components), and the constraints are binary or n-ary geometric constraints between the objects. A solution to a GCSP is a list of one location per object such that all the constraints are simultaneously satisfied. The complete solution is all such lists of locations.

In one example as illustrated in FIG. 2-A, points p1, p2 and p3 are connected by lines l1, l2 and l3. The length for lines l1, l2 and l3 are k1, k2 and k3 respectively. Assuming p1, p2 and p3 represent geographic locations, the lines l1, l2 and l3 can represents relationships among these locations. And the length k1, 2 and k3 can be used to quantify such relationships. For example, when l1, l2 and l3 represent roads connecting p1, p2 and p3, k1, k2, and k3 can represent the length of the roads l1, l2 and l3 among the three locations p1, p2 and p3.

In one embodiment, because of their sensitive nature, p1, p2 and p3 are not disclosed to any third parties. However, in order to provide valuable services to these third parties, a constraint system is constructed based on location data, without revealing the location data. A constraint system can be defined as a tuple S=(X, A, C), where:
X a set of unknown;
A is a set of parameters; and
C is a set of constraints.
   Using the FIG. 2-A example, the unknowns can be points (p1, p2 and p3) and lines (l1, l2 and l3). The parameters are the lengths (k1, k2 and k3). And the constraints (relationships among the points and lines) can be described as some of the followings:
Online (p1, l1); Online (p2, l1); Online (p2, l2); Online (p3, l2); Online (p3, l3); and Online (p1, l3).

DistancePoint2Point (p1, p2, k1); DistancePoint2Point (p2, p3, k2); and DistancePoint2Point (p2, p3, k3).

Based on the above parameters and constraints, a third party can use various algorithms in solving the CSP with various points that represent location and lines that represents specific commercial relationships. The surroundings and the topology of the location can also be taken into account in order to generate the points pk and lines lk. For example, a third party in shipping business might be interested in providing a competitive quote for shipments based on specific locations and distances. Even though the third party might not be aware of the origin and destination of a shipment, it nevertheless would like to attack business that fits the specific locations and distances. Therefore, by participating in the solving of the constraint problem, the third party would be able to discover the customers that it can serve, and utilize the information for its commercial services.

FIG. 2-B illustrates an exemplary approach in solving a private Distributed Constraint Satisfaction Problem (DistCSP). A zero-knowledge multiparty solution can be utilized to solve such a DistCSP. Multiparty means multiple agents are employed, allowing the variables and the problem being divided into “shares” and distributed among these agents. Zero-knowledge refers to the fact that secret information, e.g., users' location data, is not disclosed to any of the agents, even in the presence of dishonest agents, e.g., “cheats.” To implement such a zero-knowledge multiparty solution, secret inputs from a user are shared among the agents under a Shamir or Blakely sharing scheme. In such a sharing scheme, each location agent encrypts her share with her own public key and the agents form a mix-net, shuttling these shares and randomizing them at each permutation. The shares can also be sent directly from their creator to the mix-net, encrypted with the public key of the destination agents. The parameters are enforced by allocating ranges of possible constraints to each agent, each of which can be verified by other agents.

In one embodiment, a simple form of a distributed solution algorithm for DistCSPs is as follows:
Order all agents.
Let agent #1 (A₁) perform an assignment to its variable.

Next, agent A₁ sends the assignment on a message to agent A₂.
Every agent awaits a message from the agent before it.
When agent Aᵢ receives the message, it attempts to assign its variable, such that all constraints with former assigned variables are satisfied.
If a compatible assignment is found, agent Aᵢ adds it to the message and sends the message agent Aᵢ₊₁.
If not, it sends the same message back to agent Aᵢ₋₁.
A solution is reached when the last agent (Aₙ) finds an assignment for its variable.

A no-solution is declared after the first agent (A₁) receives a backtrack message on its last value, i.e., its domain empties.

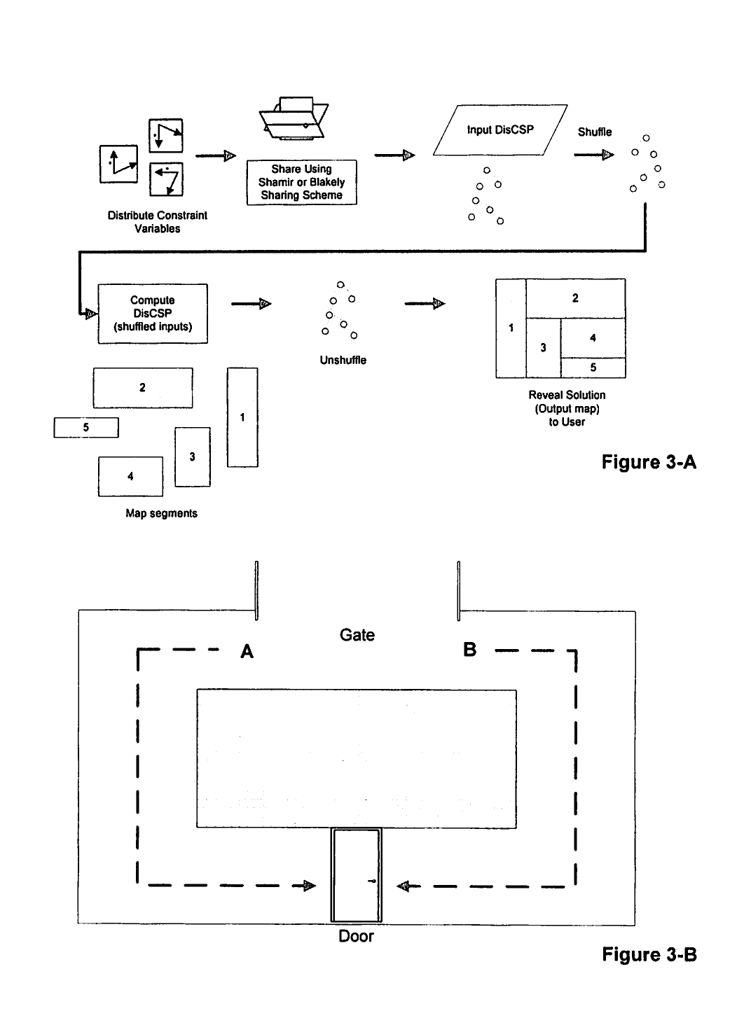

FIG. 3-A illustrates an exemplary solution to a private distributed GCSP for providing map service. When a user wishes to query a map provider, who is not trusted, for a map of their current location, the user's request for a map (or route, or directions) can consist of:
Location center (alternatively upper and lower bounding box points, a set of polygon vertices, or a center point and radius from the center)
Scale if not inferred by location input, i.e. in the case of upper lower points which define scale
   The map provider ordinarily would use the location (i.e. bounding box, or polygon) to perform a spatial query (surrounding area, intersecting region, overlapping region, etc.) to retrieve/generate a map, perhaps with route information. At every step, the map provider, and any subordinate 3^{rd} party provider, knows the user's location.

In the FIG. 3-A example, a user's map request, which may reveal the user's location, is divided and distributed to multiple map providers so that the user's location can be concealed. A Geometric Constraint Satisfaction Problem (GCSP) may be formulated that will separate the request for a map, route information, or other service info into shareable parts among multiple map providers. Once separated, the user's location is no longer retrievable from the shareable parts. The sharable parts are then distributed to the multiple providers using Shamir or Blakely Sharing Scheme. Each map provider encrypts her share with her own public key and the participants form a mix-net, shuffling these shares and randomizing them at each permutation.

Each map provider then constructs its own solution to the distributed GCSP. In one embodiment, a DCSSMS oversees the construction solutions using any of a number of well-known algorithms, e.g. the asynchronous backtracking, the asynchronous weak-commitment search, the distributed breakout, and distributed consistency algorithms. These algorithms have been further enhanced to preserve privacy using several secure multiparty computational modifications. Once the solutions are computed based on shuffled inputs, the result solutions are unshuffled and reconstructed to form a final solution. The final solution can then be sent to the user in response to the user's request for map services.

In one embodiment, the chosen solution values in terms of distance or utility constraint satisfaction are revealed to the user (or user-authorized Service Provider.)
For mapping, each provider uses the constraint to generate map tiles for a given bounding area; these are then uniquely combined (and possibly encrypted by cryptographic keys until the user decrypts them) to form a complete map. In fact, to further secure provider duties, for any given request the separation of layers (streets, geography, POIs, rivers, etc.) can be specified, further reducing the level of information that any one provider has and minimizing unnecessary resource utilization.
For directions, the constraint solutions are combined to form the route segments by the user.
For a spatial query result, constraints are used to perform an intermediate query result, and the final query result is determined by application of the final constraint set by the user.

In one embodiment, to ensure that no “cheater” participated in the above distributed algorithm or provided bogus solution, a zero-knowledge proof scheme can be employed among the participating parties, allowing each to verify the credential of any one of the other parties. Furthermore, the zero-knowledge proof can also be utilized to verity the validity of a party's provided solution. For example, a value is computed by the user, or trusted central agent, that represents the final set of constraints, e.g., a unique location id, or an id of a pertinent demographic categorization, or a set of other attributes unique to the true location. This proof, or a mapping of this proof to a user model, is distributed to all interested parties as a means of verifying the user's location, without actually knowing the user's true location, i.e. a zero knowledge proof.

FIG. 3-B illustrates an exemplary zero-knowledge proof. A zero-knowledge proof is an interactive method for one party to prove to another that a statement is true, without revealing anything other than the veracity of the statue. A zero-knowledge proof must satisfy three properties: 1) Completeness: if the statement is true, the honest verifier (that is, one following the protocol properly) will be convinced of this fact by an honest prover; 2) Soundness: if the statement is false, no cheating prover can convince the honest verifier that it is true, except with some small probability; and 3) Zero-knowledge: if the statement is true, no cheating verifier learns anything other than this fact. This is formalized by showing that every cheating verifier has some simulator that, given only the statement to be proven (and no access to the prover), can produce a transcript that “looks like” an interaction between the honest prover and the cheating verifier.

In an example as illustrated in FIG. 3-B, a left entrance “A” and a right entrance “B” lead a person from a gate to a door. A user (prover) with a key to the door wants to prove to a third party (verifier) outside of the gate that the user is in possession of the key. Without revealing the key to the third party, the user can prove to the third party that he is in possession of the key by entering either entrance A or entrance B, opening the door with the key, and returning out of entrance B or entrance A, respectively. Even in a situation that the third party does not know which entrance the user enters, after entering one of the entrances, the user can still prove to the third party by asking the third party naming an exiting entrance. If the user is 100% correct in exiting out of the entrance the third-party named, such scheme is a zero-knowledge proof that the user is in possession of the key, without revealing in any way the key to any third party.

In one embodiment, a zero-knowledge proof can be implemented to prove to any service providers a statement about a user's current or past location, without in any way identifying a user's actual location (past or present), or allowing deduction of a user's location patterns. The 3^{rd} party can only deduce from a pattern of transactions that a particular statement about location is associated with a particular demographic or behavioral or temporal attribute set, and the inverse, that a particular attribute set corresponds to one or more transactions. This is an improvement over systems that use direct access to the user's location data to map the user to a DMA, city, or zip code, and then query demographic and behavioral data for targeted preference-based marketing. The improvement is twofold: the Service Provider no longer requires specific location data for a user rendering it more private and removing the burden on the Service Provider to acquire user permissions and secure storage of such data; it provides equivalent or better targeting results since the preference attributes are encoded for an individual user relative to their actual location, rather than at a coarse level such as a zip code or DMA.

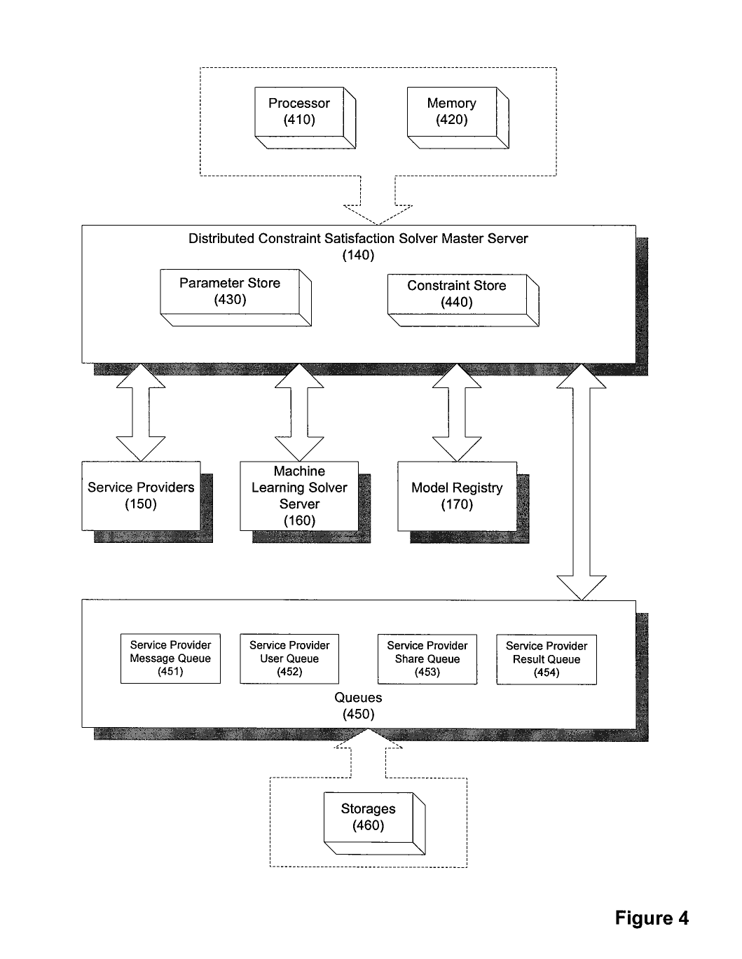

FIG. 4 illustrates an exemplary DCSSMS. The DCSSMS 140 of FIG. 4 corresponds to a DCSSMS 140 of FIG. 1; the service providers 150 of FIG. 4 corresponds to a service provider 150 of FIG. 1; the machine learning solver server 160 of FIG. 4 corresponds to a machine learning solver server 160 of FIG. 1 and the model registry 170 of FIG. 4 corresponds to a model registry 170 of FIG. 1.

In FIG. 4, the DCSSMS 140 constructs a DistCSP based on the location data from a client device or an encoded model of the user's location; organizes multiple service providers 150 in the collaboration of the secure distributed computing of a solution to the DistCSP; and/or generates a final solution based on multiparty outputs to form a demographic profile. Further the demographic profile can then be used either by the service providers 150 to serve targeted commercial services to the client device, or the demographic profile can be sent to a ad tag logic located on the client device or a third party for further processing.

In one embodiment, the DCSSMS 140 also provides and manages a zero-knowledge proof scheme, allowing a client device 110, the DCSSMS 140, and/or the service providers 150 to verify each other with respect to credential, the inputs provided, and/or the solutions generated.

In one embodiment, the DCSSMS 140 constructs a DistCSP based on location data received from a client device. Alternatively, the location data can be derived by the DCSSMS 140 by means as described above. The location data received by the DCSSMS 140 is not disclosed to or shared with any other third parties, e.g., service providers 150. Once the location data is no longer useful, the DCSSMS 140 may permanently discard the location data, thereby ensuring the location data cannot be compromised.

In one embodiment, the location data can be used for the construction of a DistCSP that is uniquely associated with a client, a client device 110, and/or a specific location. DistCSP may be previously constructed, either manually or automatically by a machine learning solver server 160, and stored in a model registry 170. It may also be dynamically generated by using the machine learning solver server 160 in response to a user request. The generated DistCSP conceals the location data as unknowns, and represents the constraint satisfaction problem with a set of parameters and constraints. The generated parameters and constraints can then be stored in a parameter store 430 and a constraint store 440 for further computation.

In one embodiment, the DCSSMS 140 can self-construct a solution to the DistCSP based on some pre-defined public parameter values. In this case, the DCSSMS 140 may use any of the various algorithms, e.g., backtracking as described above and others, in solving the problem. When multiple service providers 150 are willing to participate in the calculation, in exchange for demographic profiles that are valuable in providing targeted commercial services, the DCSSMS 140 may form a distributed computing network, with each of the service providers 150 acting as an agent. Alternatively, the DCSSMS 140 can also act as one of the agents. The algorithm as described above is run by agents that communicate by sending and receiving messages.

In one embodiment, the parameters and the constraints are first distributed among agents. The parameters are distributed by the DCSSMS 140 via a Service Provider Initialization Message to a number of peer service providers 150 by allocating ranges of possible constraints to each participant, each of which can be verified by other participants. Once distributed, the constraints form a constraint network among the agents dictating how a computation should be conducted and coordinated among the agents. During computation, messages containing information about assignments of values to variables and refutations of assignments are transmitted.

In one embodiment, the DCSSMS 140 oversees the construction of a solution to the DistCSP using any of a number of well-known algorithms, e.g. the asynchronous backtracking, the asynchronous weak-commitment search, the distributed breakout, and distributed consistency algorithms. These algorithms have been further enhanced to preserve privacy using several secure multiparty computational modifications. In one embodiment, the computation ends once a solution is constructed. The solution can in a form of demographic profile, or can be further processed to generated such demographic profiles.

Alternatively, the DCSSMS 140 can organize the agents into multiple groups, each generating an intermediate solution to be used for constructing a final solution. In such a case, messages can be encrypted and shuffled as described above during transmission. Thus, not a single agent (including the DCSSMS 140) is allowed in, or is capable of, deriving location data from the parameters and constraints of the DistCSP. Intermediate solutions generated by the agents can then be decrypted and unshuffled to form a final solution. Similarly, the final solution can be presented to the client or other service providers 150 as valuable demographic profiles.

In one embodiment, after the final solution is delivered, the DCSSMS 140 can provide a zero-knowledge proof of the client's location data to any parties who is interested or wants to challenge the validity of the data. For example, an auction site may need assurance that the winning bidder is indeed a valid user. Alternatively, the client may need proof that the service providers do not include a “cheater” providing bogus information. Further, either the client or the service providers may want the DCSSMS 140 a proof that the final solution is mathematically constructed correctly. In any of these cases, a zero-knowledge proof is advantageous in providing a high degree of guarantee that the system is properly functioning in serving each of the participating parties promised information.

In one embodiment, the DCSSMS 140 communicates with the service providers 150 via multiple queues 450. Queues allow indirect, asynchronous communications between the DCSSMS 140 and any one of the service providers 150 by placing the requests and corresponding responses in multiple queues 450. The service providers 150 can monitor the queues 450 for tasks allocated by the DCSSMS 140, or the DCSSMS 140 can monitor the queues 450 for messages and results generated by the service providers 150. For example, when a service provider initializes a message for joining the distributed computing environment managed by the DCSSMS 140, the initialization message can be stored in a service provider message queue 451, in which the DCSSMS 140 can pick up the message at a later time for processing. Similarly, users generated secret messages, which are intend for one or more specific agents, can be stored in a service provider user queue 452. During distributed computation of the DistCSP, the messages among the agents can be stored in a service provider share queue 453. And once a result is generated, each of the agent may put its intermediate solution or final solution into a service provider result queue 454.

In one embodiment, the queues 450 are implemented by using various message bus or message queue utilities. The message bus or message queue utilities maintain the queues 450 and manage the asynchronous communications among the various parties. Alternatively, the queues 450 may be stored in any form of storages 460. Examples of storages 460 include, but are not limited to, conventional magnetic or optical disks, volatile or non-volatile memory, etc. Utilizing the queues 450 for asynchronous communications can be advantageous when agents of the distributed computing are dynamically added or deleted.

In one embodiment, the DCSSMS 140 includes one or more processors 410, memory 420, and/or other components. The processor(s) 410 may include central processing units (CPUs) for controlling the overall operation of the DCSSMS 140. In certain embodiments, the processor(s) 410 accomplish this by executing software or firmware stored in memory 420. The processor(s) 410 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 420 is or includes the main memory of the DCSSMS 140. The memory 420 represents any form of random access memory (RAM), read-only memory (ROM), flash memory (as discussed above), or the like, or a combination of such devices. In use, the memory 420 may contain, among other things, a set of machine instruments which, when executed by the processor 410, causing the processor 410 to perform embodiments of the present invention. In one embodiment, a DCSSMS 140 is implemented with a computer system with sufficient processing power and storage capacities. Alternatively, the DCSSMS 140 may be implemented with more than one computer system.

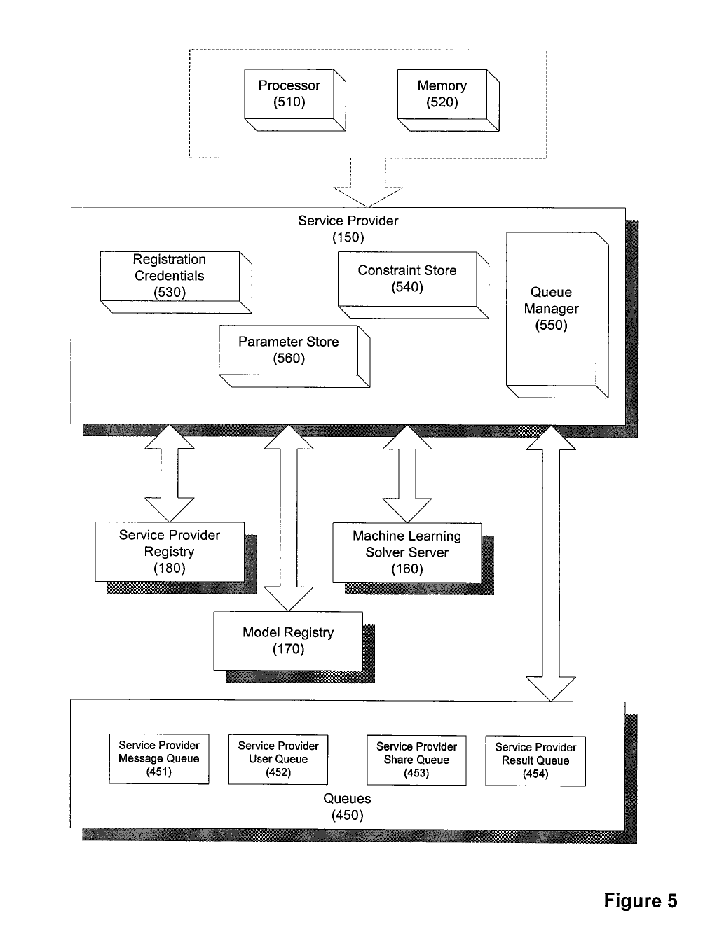

FIG. 5 illustrates a service provider 150, according to certain embodiments of the present invention. The service provider registry 180 of FIG. 5 corresponds to a service provider registry 180 of FIG. 1; the model registry 170 of FIG. 5 corresponds to a model registry 170 of FIG. 1; the machine learning solver server 160 of FIG. 5 corresponds to a machine learning solver server 160 of FIG. 1 and the queues 450 of FIG. 5 corresponds to the queues 450 of FIG. 4. Alternatively, components of FIG. 5 perform functions in addition to, or in lieu of, functions performed by corresponding components of FIG. 1 and FIG. 5, as described below. Alternatively, components of FIG. 5 perform functions in addition to, or in lieu of, functions performed by corresponding components of FIG. 1, as described below.

In one embodiment, a service provider 150 may be interested in the demographic profiles provided in a multiparty location based service environment 130 of FIG. 1. The service provider 150 can also participate in functions operating over location and preference information that identify users. The approach allows a shared computation with no trusted parties, or where a shared system employs a trusted central agent because the data provided by any parties can be verifiable via zero-knowledge proofs.

In one embodiment, a client can be added or removed at any time to revoke or grant participation. Authentication of the client user is performed by registration credentials via digital cryptographic signature. Data is protected with encryption. The user's public key is derived from the phone number and/or a user unique id using an Identity Based Cryptosystem, Public Key Cryptographic System, and/or a One Time Password scheme. Additionally, there is a capability to perform offline encryption and signature operations for disconnected use. This allows trusted authenticated service provider agents providing services to the client user, or in a peer-based system for client users amongst themselves, to access the specific location of a properly authenticated, consenting user. Once authenticated, the client user and the service provider agent's credentials are verifiable via a zero-knowledge proof, and can be saved to a service provider registry 180.

In one embodiment, required parameters and constraints can be retrieved from a model registry 170 and/or a machine learning solver server 160, and stored in a parameter store 560 and/or a constraint store 540. If a service needs to add location specific data, for example event locations or nearby businesses, the labeling can also be framed in the DisCSP combined with the location constraints or as a completely independent GCSP problem in parallel.

In one embodiment, the location based service request from a client device 110 can be fulfilled by the following sequence: the location-based service provider 150 participants register with a directory of service providers 150 via a Service Provider Registration Message; each service provider 150 sends a Select Public Parameters Message to the model repository 170; the public parameters of the problem consist of a set of variables X, where there is a unique variable tuple for each location constraint. For example, the variables could be utility attributes used to define the customer preferences of a location.

Afterward, there is a function (Dk(s,I) for each provider participant Ak, which maps a tuple of values (XO.Xi.Xn) to an element of Ik (the location constraint of Ak for). This function could be determined by a machine learning algorithm and could encode a ring, Voronoi tile, or Huff model, or other geometric or algebraic construct. The selection of the variable family and the mapping function could be determined dynamically and could change over time for a provider by use of a model repository 170 or network of such repositories of variable and mapping choices. The service provider 150 requests a new Constraint System from the machine learning solver server 160 via a CSP Request Message.

In one embodiment, the service provider has two options in requesting an initial solver model. They can program a specific model into the domain template, requiring some knowledge of constraint programming, or they can have the system generate a starting model. In some cases, a combination of both approaches is used. This allows the service provider 150, for example an advertiser or advertising network, to develop unique parameters and models that can produce highly optimized results specific to their expertise or data. In the end, the service providers 150 (agents) post their results to the DCSSMS 140 for final delivery to the originating service provider.

In one embodiment, the service provider 150 communicates with the DCSSMS 140 and the machine learning solver server 160 synchronously. Alternatively, the service provider 150 can communicate with the above servers asynchronously via a queue manager 550. The queue manager 550 stored the messages as described above to different queues of queues 450. Each of the queues 450 functions similarly as the queues 450 of FIG. 4.

In one embodiment, the service provider 150 includes one or more processors 510, memory 520, and/or other components. The processor(s) 510 may include central processing units (CPUs) for controlling the overall operation of the service provider 150. In certain embodiments, the processor(s) 510 accomplish this by executing software or firmware stored in memory 520. The memory 520 is or includes the main memory of the service provider 150. In use, the memory 520 may contain, among other things, a set of machine instruments which, when executed by processor 510, causing the processor 510 to perform embodiments of the present invention.

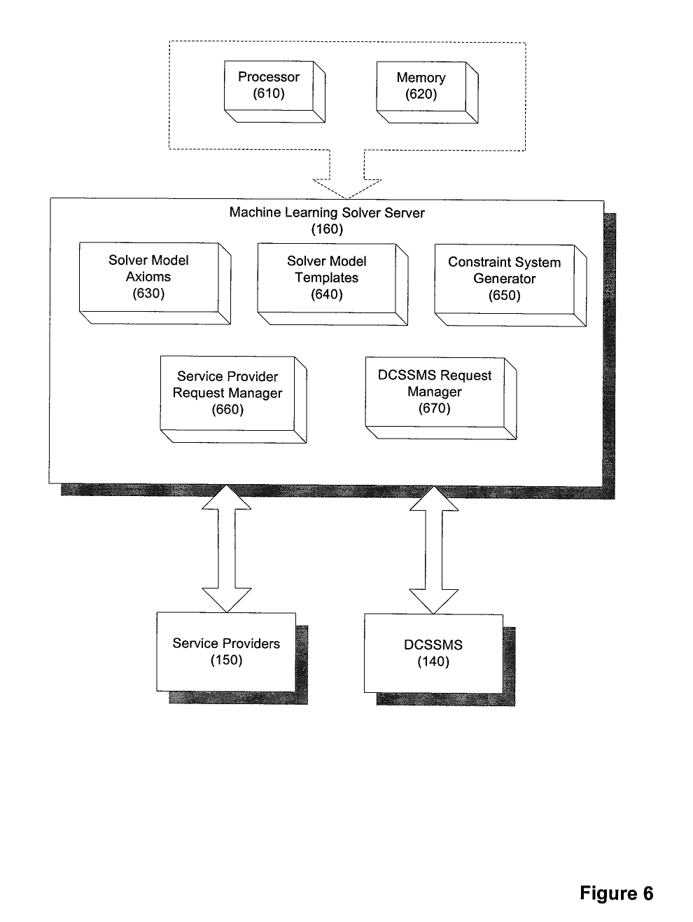

FIG. 6 illustrates a machine learning solver server 160, according to certain embodiments of the present invention. The machine learning solver server 160 of FIG. 6 corresponds to a machine learning solver server 160 of FIG. 1; the service provider 150 of FIG. 6 corresponds to a service provider 150 of FIG. 1; and the DCSSMS 140 of FIG. 6 corresponds to a DCSSMS 140 of FIG. 1. Alternatively, components of FIG. 6 perform functions in addition to, or in lieu of, functions performed by corresponding components of FIG. 1, as described below.

In one embodiment, machine learning algorithms, such as Support Vector Machine (SVM), Fuzzy Neural Network (FNN), Bayesian Classifier, or Genetic Algorithm, etc, are tools and techniques capable of learning from observations and experiences based on training data sets. The rules and algorithms learned from experience data can then be utilized to predict outputs from new inputs. Machine learning algorithms are particularly effective at finding optimal or near-optimal solutions to problems with large numbers of decision variables and consequently large numbers of possible solutions. Machine learning algorithms such as SVM and/or FNN can simplify the computation requirements in generating the parameters and domain definitions that can be utilized to form constraint satisfaction problems.

In one embodiment, a machine learning solver server 160 includes a constraint system generator 650 to automatically define one or more constraint systems, using one or more machine learning algorithms and a set of production rules. The constraint system generator 650 uses an initial set of axioms stored in solver model axioms 630 for the family of problems registered in the model repository 170 (not shown in FIG. 6). Afterwards, the constraint system generator 650 uses a template selected from solver model templates 640 for generating solver models for these domains. Once generated, the solver models can either be stored in the model repository 170, or be directly provided to the DCSSMS 140 and/or service providers 150 for direct processing.

In one embodiment, the creating, analysis, training and testing of constraint systems are further described in disclosures of an application with Ser. No. 12/144,606. The disclosures of the application are hereby incorporated.

In one embodiment, the machine learning solver server 160 includes one or more processors 610, memory 620, and/or other components. The processor(s) 610 may include central processing units (CPUs) for controlling the overall operation of the machine learning solver server 160. In certain embodiments, the processor(s) 610 accomplish this by executing software or firmware stored in memory 620. The memory 620 is or includes the main memory of the machine learning solver server 160. In use, the memory 620 may contain, among other things, a set of machine instruments which, when executed by processor 610, causing the processor 610 to perform embodiments of the present invention.

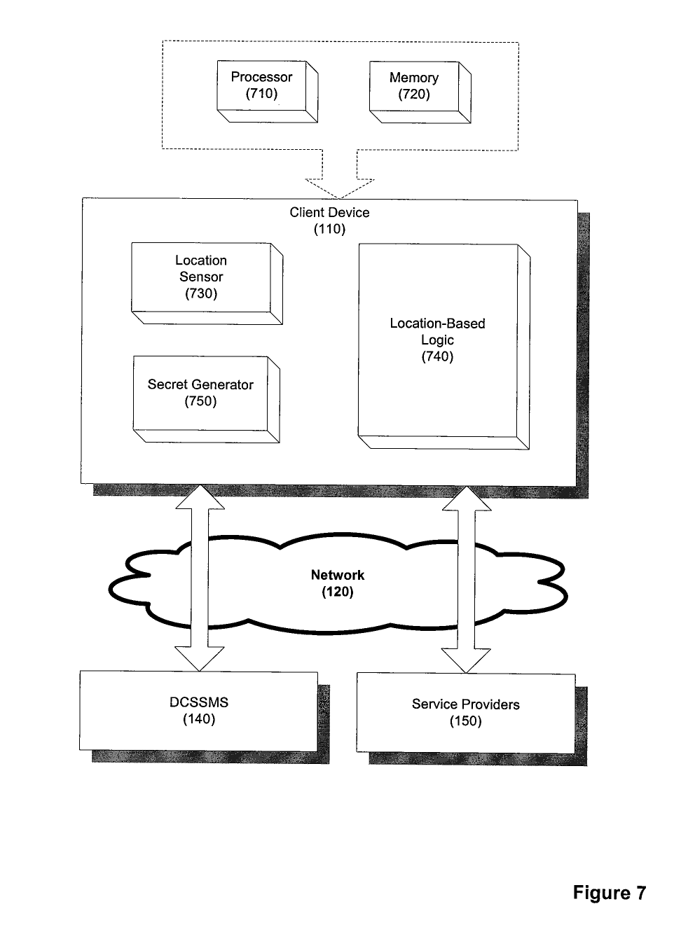

FIG. 7 illustrates a client device 110, according to certain embodiments of the present invention. The client device 110 of FIG. 7 corresponds to a client device 110 of FIG. 1; the DCSSMS 140 of FIG. 7 corresponds to a DCSSMS 140 of FIG. 1; and the service providers 150 of FIG. 7 corresponds to service providers 150 of FIG. 1. Alternatively, components of FIG. 7 perform functions in addition to, or in lieu of, functions performed by corresponding components of FIG. 1, as described below.

In FIG. 7, a client device 110 includes a location sensor 730, a secret generator 750, and/or optionally a location-based logic 740. The location sensor 730, such as a GPS sensor or a WIFI detector with location estimation capability, can generate a real-time or near real-time location information of the client device. Alternatively, location information can be provided by a user of the client device 110, or be implicitly determined based on IP address, wireless signals, or mobile signals, as described above. In such a case, the location sensor 730 contains the necessary logic to extract from the user input, or derive from IP address or signals, the location information.

In one embodiment, a secret generator 750 generates a user secret generation message from the client device 110. The secret generator 750 decides secret inputs pk,Ik for each tuple defining a location constraint, by taking into account both the surroundings and the topology (drive time, habitability, etc.) of the location. This user secret generation message can also be derived from a user-generated password, cryptographic key, or other hardware on the client device 110. The secret inputs are shared by the DCSSMS 140 to each service providers 150 with a Shamir or Blakely sharing scheme using a Share Delivery Message posted to the service provider's Share Queue. Each location service provider 150 encrypts her share with her own public key and the participants form a mix-net, shuffling these shares and randomizing them at each permutation.

In one embodiment, a location-based logic 740 processes the responses generated by the DCSSMS 140 and/or the service providers 150. If a response is in a form of location-based demographic profiles, the location-based logic 740 can perform further analysis on the demographic profiles in order to generate targeted commercial services. If the response is what the client device 110 is requesting for, e.g., a map, the location-based logic 740 can process and display the response on the client device 110.

Alternatively, location-based logic 740 may also act as a prover or a verifier in performing zero-knowledge proof. For example, if a service provider 150 requires a proof that the client device 110 is in deed at the location indicated by location data sent to the service provider 150, the location-based logic 740 can interact with the service provider 150 to perform a zero-knowledge proof communications. Likewise, the location-based logic 740 can interact with either the DCSSMS 140 or any service provider 150 to validate their credential and the accuracy of any solutions sent by the DCSSMS 140 and/or the service provider 150.

In one embodiment, the client device 110 includes one or more processors 710, memory 720, and/or other components. The processor(s) 710 may include central processing units (CPUs) for controlling the overall operation of the client device 110. In certain embodiments, the processor(s) 710 accomplish this by executing software or firmware stored in memory 720. The memory 720 is or includes the main memory of the client device 110. In use, the memory 720 may contain, among other things, a set of machine instruments which, when executed by processor 710, causing the processor 710 to perform embodiments of the present invention.

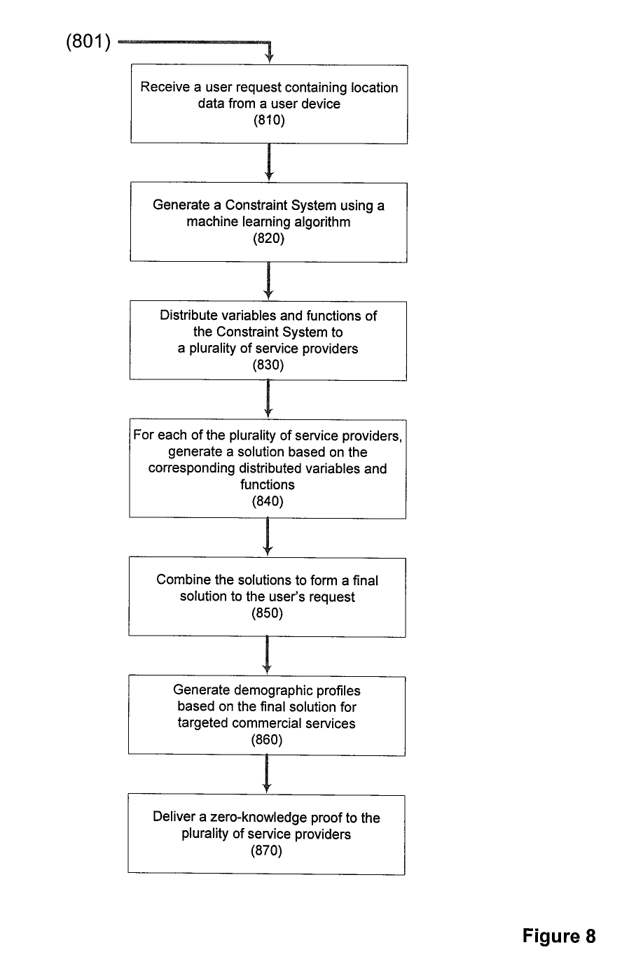

FIG. 8 illustrates an exemplary flowchart for a method 801 to provide secure multiparty location based services, in accordance with certain embodiments of the present invention. The method 801 may be performed by processing logic that may comprise hardware (e.g., special-purpose circuitry, dedicated hardware logic, programmable hardware logic, etc.), software (such as instructions that can be executed on a processing device), firmware or a combination thereof. In one embodiment, method 801 can be stored in memory, and/or be executable by a processor of computer system. Further, 810-870 may or may not being processed in a specific order as shown in FIG. 8.

At 810, a user input is received from a client device similar to the client device 110 of FIG. 1. The user input contains location data collected in means as described above. At 820, based on the user input and the embedded information, one or more models are retrieved. Each of the models can be a constraint system. In one embodiment, the models are generated using a machine learning algorithm. Alternatively, a model can be manually generated and stored in a model depository. The models do not contain the location data received from the client device 110. Each of the models represents a CSP with a set of variables and mapping functions representing the parameters and constrains of the CSP.

In one embodiment, Each of the models (CSPs) is formed by construction of one or more family of variables and mapping functions as the following:
A constraint system tuple S=(X,A,C) where X is a set of location-dependent private unknowns, A is a set of public parameters, C is a set of public constraints
A recipient computer system agent,
The necessary keying materials, integrity checksum data, and other data needed to employ a cryptographic system to secure the private data in an open, untrusted computer network,
The set of unknowns consists of private location data pertaining to a user or a user's device, for example: location data sufficient to produce a map of an area surrounding to a user's location, or a route segment for a route intersecting the user's location, or planned location,
The set of parameters relevant to location determination, consisting of a range of values that are not location specific,
The set of constraints that define relationships among the variables in the set of location data in X.

In one embodiment, a set of CSP variables and mapping functions are constructed utilizing a machine learning algorithm. Examples of such machine learning algorithms include a Support Vector Machine (SVM), Fuzzy Neural Network (FNN), Bayesian Classifier, or Genetic Algorithm, etc.

In one embodiment, at 830, the variables and mapping functions are divided into shares and distributed to a plurality of service providers acting as agents. Thus, the CSP can be construed as a DistCSP and solved by the agents. Such approach is advantageous because not a single agent would be working on the complete CSP, thereby reducing the risk of abusing location data. The shares are then distributed in a secure way to multiple agents (including service providers and DCSSMS) in a way that does not disclose the secret information, e.g., the user's location, to any of the participating agents, even in the presence of dishonest agents, e.g., “cheats.”

In one embodiment, sharing and distributing of the CSP can be accomplished by means of a Blakely or Shamir sharing scheme, employing an El Gamal cryptosystem, mix-net, or Yao's construction. Before distributing, a shuffling operation can be optionally performed across multiple computer system agents using mixnet, evaluation of an algebraic circuit, or other multiple agent shuffling algorithms. At 840, each of the agents participates in the DistCSP computing and generates intermediate solutions based on the corresponding distributed variables and functions. An exemplary algorithm for conducting such computing is described above.

In one embodiment, at 850, an unshuffling operation, which is the inverse of an shuffling operation, can be optionally performed before combine the solutions to form a final solution to the user's request. Once a zero-knowledge multiparty solution is constructed, the solution can be revealed to the client device or other agents for further usage. A solution to the DistCSP includes a set of solution values. The solution values can be values of X that pertain to a user's location, without revealing to any participant other than the user the user's location or sufficient data to deduce the user's location. Or the solution value can be metadata related to the user's position, such as points of interest, driving directions, nearby users, or other location-based information.

At 860, the solution can be used to generate demographic profiles that are valuable for targeted commercial services. Targeted commercial services include advertisements, marketing messages, promotions, retail transactions, and/or retail fraud detection, etc. Further, demographic profiles can also be used for retail transaction fraud detections. A determination can be made based on these demographic profiles to pick the best scenario in delivering location based marketing information. Or, a ROI analysis can be conducted based on these profiles.

In one embodiment, the solution can be used to predict a set of attribute data such as relevance, category, key word, and/or other metadata. Still, the solution and the set of attribute data do not contain the user location information. Also, the solution can be used to predict a geometric and/or geographic result such as distance, midpoint, travel time, k-nearest points, routes, or other spatially relevant data. The targeted commercial services to the user device can then be based on the relevance, category, key word, Metadata, geometric and/or geographic results.

In one embodiment, the solution can be directly related to the location data submitted from a client device 110. In this case, the solution to the DistCSP to the user can be in the form of a map, route, driving directions, list of nearby points of interests, nearby peer users, nearby events, or the results of any type of spatial query operation such as whether the user's location is contained in a polygon, intersects another geometric element, e.g. a line or point, or is within a distance or time from another point, points, polygon, line, or boundary. The solution can also be delivered to the user via wired or wireless data networks, direct computer display, printed output, or broadcast signal.

In one embodiment, the solution in a location mapping format can be published back to a network repository for the purpose of indexing for search. This allows location aware search engines to index, organize, and present a record of a user's location-specific events in an anonymous, secure way. Search users will see the preference choices of users for a given location, or set of locations and will be able to observe patterns, themes, and topics for any given geographical location. However, no user or search engine will be able to discern any individual's record as it pertains to a specific location, and the mapping will be devoid of extremely unique location contexts, e.g. residential areas, to prevent inference of a user's private locations.

In one embodiment, the shared private data and intermediary computational results during the shuffling and/or unshuffling operations are encryption and digitally signed. The encryption and signature process utilizes any of the following: an identity based cryptosystem, a public key cryptosystem, a shared key, or symmetric key cryptosystem, a secure One Time Password protocol, a secure hashing protocol, and/or a secure pseudo- or true-random number generator, etc.

In one embodiment, at 870, for all interested parties, a zero knowledge proof of the user's location for use in analysis purposes can be provided without revealing the user's actual geographic location or data sufficient to deduce said location. The zero knowledge proof delivered to the interested agents can be a unique identifier, a computer software program or model that can be evaluated and generate a specific result pertaining to the user's location, a computer software program or model that transforms the user's actual location to a new coordinate system or hyperplane, or an algorithm that allows for verification of the proof's soundness and completeness.

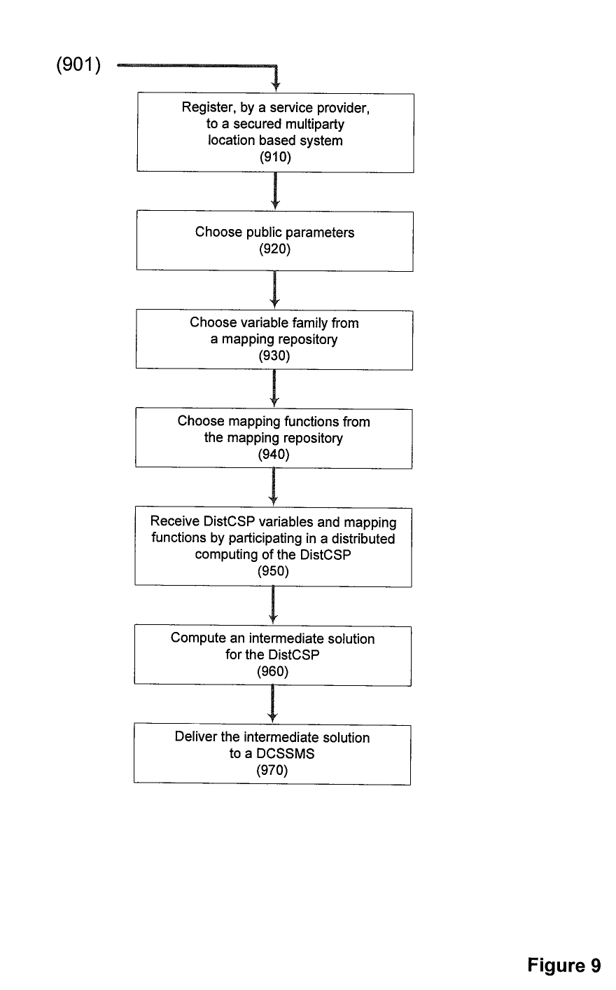

FIG. 9 illustrates an exemplary flowchart for a method 901 to participate in providing secure multiparty location based services, in accordance with certain embodiments of the present invention. The method 901 may be performed by processing logic that may comprise hardware (e.g., special-purpose circuitry, dedicated hardware logic, programmable hardware logic, etc.), software (such as instructions that can be executed on a processing device), firmware or a combination thereof. In one embodiment, method 901 can be stored in memory, and/or be executable by a processor of computer system.

In one embodiment, at 910, a service provider 150 determines to participate in a secured multiparty location based system as illustrated in FIG. 1. The service provider 150 send a initialization message to a DCSSMS 140, and its credential is stored in a service provider registry 180. At 920, the service provider chooses public parameters that are specifically tailored to it. At 930, the service provider 150 chooses variable family by querying a model repository 170. At 940, the service provider 150 chooses mapping functions by querying the model repository 170. Afterward, the service provider 150 is ready to participate in a distributed computing of a solution to a DistCSP.

In one embodiment, at 950, the service provider 150 monitors task queues for any new computing tasks. Once a new task appears in the task queue, the service provider 150 sends a CSP request message in the processing of obtaining a model from the machine learning solver server 160. The model represents a CSP which includes custom variables and mapping functions. At 960, the service provider 150 computes an intermediate solution for the DistCSP. Depending on the algorithm, the service provider 150 may be invoked multiple times for such computation. Afterward, at 970, the service provider 150 may deliver the intermediate solution to a DCSSMS 140 for constructing a final solution.

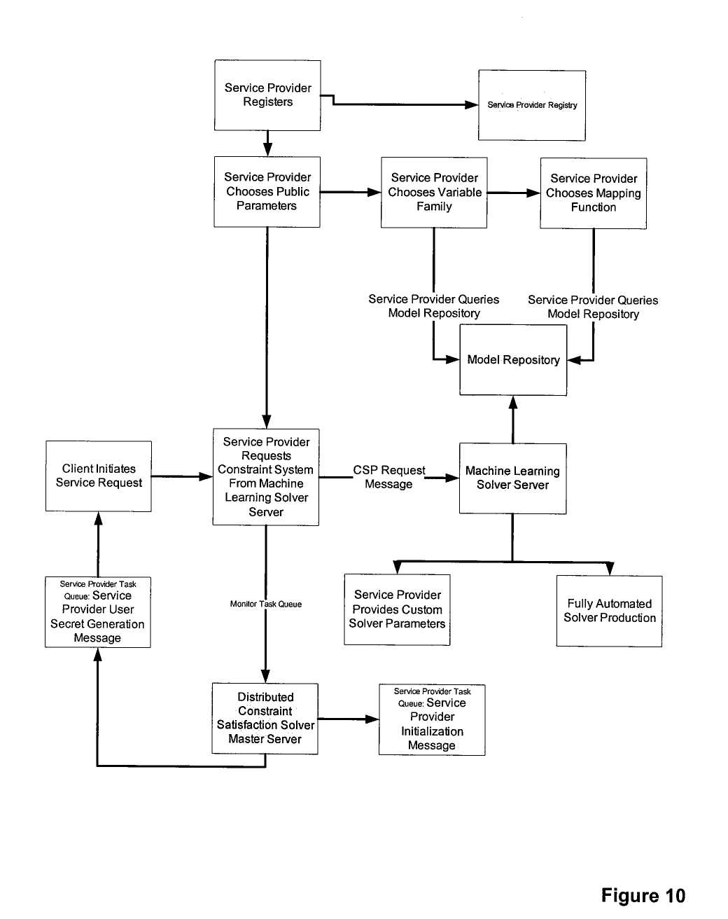

FIG. 10 illustrates an exemplary flowchart for interactions among multiple components in providing secure multiparty location based services, in accordance with certain embodiments of the present invention. In FIG. 10, a DCSSMS 140, service providers 150 and a machine learning solver server 160 interact among each other in performing certain embodiments of the present invention as illustrated in FIG. 8 and FIG. 9.

Thus, systems, methods and apparatus for secure multiparty location based services have been described. The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable medium and may be executed by one or more general-purpose or special-purpose programmable microprocessors. A “machine-readable medium”, or a “machine-readable storage medium”, as the term is used herein, includes any mechanism that provides (i.e., stores and/or transmits) information in a form accessible by a machine (e.g., a computer, network device, personal digital assistant (PDA), manufacturing tool, any device with a set of one or more processors, etc.). For example, a machine-accessible medium includes recordable/non-recordable media (e.g., read-only memory (ROM); random access memory (RAM); magnetic disk storage media; optical storage media; flash memory devices; etc.), etc.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method, comprising:
receiving a user input from a user device of a user, wherein the user input contains user location information;
constructing and retrieving a model based on the user location information, wherein the model is a constraint satisfaction problem defined by a set of variables and mapping functions;
dividing the set of variables and mapping functions into a plurality of shares;
distributing the plurality of shares to a plurality of agents, wherein each of the plurality of agents participates in finding a solution to the constraint satisfaction problem;
predicting a demographic profile based on the solution, wherein the solution does not contain the user location information.

2. The method as recited in claim 1, further comprising:
predicting a set of metadata based on the solution, wherein the solution does not contain the user location information.

3. The method as recited in claim 1, further comprising:
predicting a geometric or geographic result based on the solution, wherein the solution does not contain the user location information.

4. The method as recited in claim 1, further comprising:
providing targeted commercial services to the user device based on the predicted demographic profile.

5. The method as recited in claim 1, wherein the set of variables and mapping functions for the constraint satisfaction problem is constructed by using a machine learning algorithm.

6. The method as recited in claim 5, wherein the machine learning algorithm is a Support Vector Machine (SVM), a Fuzzy Neural Network (FNN), a Bayesian Classifier, a Genetic Algorithm, a probabilistic model, or a statistical model.

7. The method as recited in claim 1, wherein the set of variables and mapping functions for the constraint satisfaction problem does not reveal the user location information to the plurality of agents.

8. The method as recited in claim 1, wherein the demographic profile is associated with the user.

9. The method as recited in claim 1, wherein the demographic profile is associated with an aggregation of multiple users.

10. The method as recited in claim 1, wherein the model is associated with the user.

11. The method as recited in claim 1, wherein the model is associated with an aggregation of multiple users.

12. The method as recited in claim 1, wherein the plurality of shares is shared securely to the plurality of agents without disclosing the user location information.

13. The method as recited in claim 12, wherein the plurality of shares is shared securely by means of a Blakely or Shamir sharing scheme.

14. The method as recited in claim 1, further comprising:
providing a zero-knowledge proof for validating information relevant to the user location information.

15. The method as recited in claim 1, further comprising:
providing a zero-knowledge proof for validating each of the plurality of agents.

16. The method as recited in claim 1, further comprising:
providing a zero-knowledge proof for validating the solution.

17. The method as recited in claim 1, wherein the distributing of the plurality of shares to a plurality of agents further comprises:
optionally performing a shuffling operating across the plurality of agents; and
upon finding intermediate solutions by the plurality of agents to the constraint satisfaction problem, optionally performing an unshuffling operation on the intermediate solutions across the plurality of agents.

18. The method as recited in claim 1, wherein the method is embodied in a machine-readable medium as a set of instructions which, when executed by a processor, cause the processor to perform the method.

19. A method, comprising:
registering to a secured multiparty location based system;
participating in a distributed computing of a Distributed Constraint Satisfaction Problem (DistCSP), wherein the DistCSP is obtained based on a user request, and the user request contains location information of a user;
receiving a share of variables and mapping functions associated with the DistCSP;
computing a solution for the DistCSP based on the share of variables and mapping functions; and
delivering the solution to the secured multiparty location based system, wherein the solution is utilized in generating a demographic profile of the user.

20. The method as recited in claim 19, further comprising
validating the location information of the user without accessing the location information by using a zero-knowledge proof.

21. The method as recited in claim 19, wherein the DistCSP, the solution, and the demographic profile do not contain the location information.

22. The method as recited in claim 19, wherein the method is embodied in a machine-readable medium as a set of instructions which, when executed by a processor, cause the processor to perform the method.

23. A system, comprising:
a machine learning solver server for generating a Distributed Constraint Satisfaction Problem (DistCSP) with a machine learning algorithm, and for providing the DistCSP based on location information obtained from a user device; and
a Distributed Constraint Satisfaction Solver Master Server (DCSSMS) for secure multiparty computing a solution to the DistCSP and generating a demographic profile of the user, wherein the DistCSP, the solution, and the demographic profile do not contain the location information.

24. The system as recited in claim 23, further comprising:
a plurality of service providers for participating in the secure multiparty computing of the DistCSP, wherein the location information is not disclosed to any one of the plurality of service providers.

25. The system as recited in claim 23, wherein each of the plurality of service providers is capable of validating the location information of the user without accessing the location information by using a zero-knowledge proof.
